(19) United States
(12) Patent Application Publication
(10) Pub. No.: US 2011/0153783 A1
(43) Pub. Date: Jun. 23, 2011

(54) APPARATUS AND METHOD FOR EXTRACTING KEYWORD BASED ON RSS

(75) Inventors: Jooyoung LEE, Seoul (KR); Jeho NAM, Daejeon (KR)

(73) Assignee: Eletronics and Telecommunications Research Institute, Daejeon (KR)

(21) Appl. No.: 12/878,637

(22) Filed: Sep. 9, 2010

(30) Foreign Application Priority Data
Dec. 21, 2009 (KR) 10-2009-0128257

(51) Int. Cl. G06F 15/16

(52) U.S. Cl. 709/219

(57) ABSTRACT

An apparatus and method for detecting a keyword are provided. The method for detecting a keyword includes collecting RSS information, extracting terms from the RSS information, calculating importance levels of the terms, and selecting a keyword from among the terms based on the importance levels.

### CROSS-REFERENCE TO RELATED APPLICATION

This application claims the benefit of Korean Patent Application No. 10-2009-0128257, filed on Dec. 21, 2009, in the Korean Intellectual Property Office, the disclosure of which is incorporated herein by reference.

### BACKGROUND

1. Field of the Invention

The present invention relates to an apparatus and method for extracting a keyword, and more particularly, to an apparatus and method for extracting a keyword based on Really Simple Syndication (RSS) information.

2. Description of the Related Art

Really Simple Syndication (RSS) refers to a standard format associated with distribution and collection of contents, and enables collection of contents, such as in news, magazines, or blogs, in various positions using a scheme automated in compliance with a standardized scheme. In particular, RSS may provide a function of quickly and easily collecting updates related to desired topics depending on a user preference or a purpose of an application. Accordingly, RSS is mainly used for updating or distributing information, and is being actively utilized in services for providing media contents, such as in news, via the Internet.

Additionally, there is a desire for technologies to quickly and easily acquire an issue keyword in a predetermined field when advertisements and web services are provided over the Internet.

### SUMMARY

An aspect of the present invention provides a keyword detecting apparatus and method that may extract a keyword from Really Simple Syndication (RSS) information, to easily and quickly acquire an issue keyword in a predetermined field.

Another aspect of the present invention provides a keyword detecting apparatus and method that may further extend an application service model of an RSS technique using an RSS enabling quick and easy acquisition of updates regarding a desired field.

According to an aspect of the present invention, there is provided an apparatus for detecting a keyword, the apparatus including an RSS collector to collect RSS information, and a keyword detector to analyze the RSS information and to detect a keyword.

The RSS collector may include an RSS information receiving module to receive RSS information from a plurality of RSS servers, and a database to maintain the received RSS information.

The RSS information receiving module may determine the RSS servers based on range data that is set in advance, and may request the RSS servers to transmit the RSS information.

The keyword detector may include a term acquiring module to extract terms from the RSS information, an importance calculating module to calculate importance levels of the terms, and a keyword detecting module to select a keyword among the terms based on the importance levels.

The keyword detector may further include an RSS interpretation module to extract a unit element from the RSS information. Here, the term acquiring module may extract terms from the unit element, and the terms may form the unit element.

The term acquiring module may extract the terms based on at least one of a morpheme analysis algorithm and a whitespace separation algorithm.

The importance calculating module may calculate the importance levels of the terms based on at least one of a frequency of an occurrence, a scarcity level, and a user preference with respect to the terms.

The importance calculating module may calculate the importance levels of the terms based on a Term Frequency-Inverse Document Frequency (TF-IDF) of the terms.

The importance calculating module may calculate a Term Frequency (TF) of a first term among the terms, may calculate a Document Frequency (DF) of the first term, and may calculate an importance level of the first term based on the calculated TF and the calculated DF.

The keyword detecting module may select, as the keyword, a term having an importance level being equal to or greater than a reference value, from among the terms.

According to another aspect of the present invention, there is provided a method for detecting a keyword, the method including collecting RSS information, extracting terms from the RSS information, calculating importance levels of the terms, and selecting a keyword from among the terms based on the importance levels.

The calculating may include calculating a TF of a first term among the terms, calculating a DF of the first term, and calculating an importance level of the first term based on the calculated TF and the calculated DF.

The selecting may include selecting the first term as the keyword based on the importance level of the first term.

### EFFECT

According to embodiments of the present invention, it is possible to extract a keyword from Really Simple Syndication (RSS) information, to quickly and easily acquire an issue keyword in a predetermined field.

Additionally, according to embodiments of the present invention, it is possible to further extend an application service model of an RSS technique using an RSS enabling quick and easy acquisition of updates regarding a desired field.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating Really Simple Syndication (RSS) servers and a keyword detecting apparatus according to an embodiment of the present invention;

FIG. 2 is a block diagram illustrating a keyword detecting apparatus according to an embodiment of the present invention;

FIG. 3 is a flowchart illustrating a keyword detecting method according to an embodiment of the present invention;

FIG. 4 is a flowchart illustrating an operation of calculating importance levels of terms according to an embodiment of the present invention; and

FIG. 5 is a flowchart illustrating an operation of selecting a keyword among terms according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

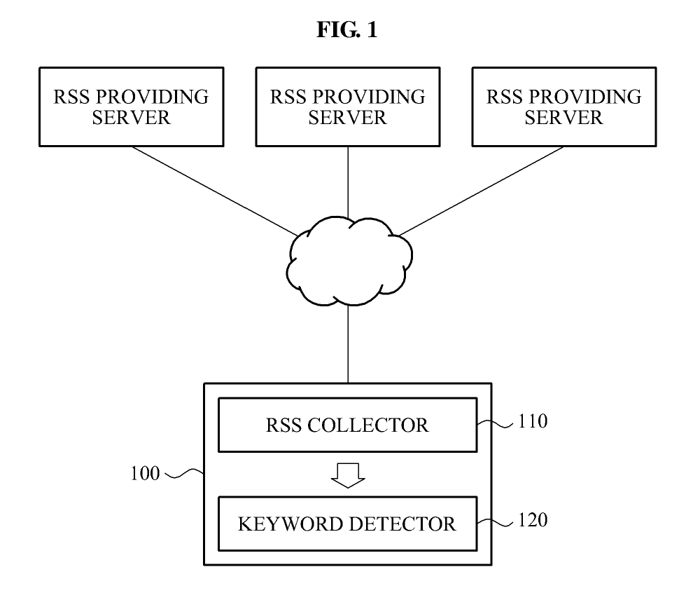

FIG. 1 is a diagram illustrating Really Simple Syndication (RSS) servers, and a keyword detecting apparatus 100 according to an embodiment of the present invention.

The keyword detecting apparatus 100 shown in FIG. 1 may acquire RSS information that is scattered online, from the RSS providing servers, may collect information required depending on a purpose of an application or a user preference, among the acquired RSS information, and may store the collected information. Additionally, the keyword detecting apparatus 100 may extract terms from the collected RSS information, may calculate importance levels for each of the extracted terms, and may select a keyword based on the importance levels.

The term “RSS” as used herein stands for “Really simple Syndication” or “Rich Site Summary”, and is associated with an eXtensible Markup Language (XML)-based content syndication standard or a standard technology that is designed to easily provide users with updated information through an Internet website where contents are frequently updated, for example a news site or a blog. For example, when a user enters an address provided by a website in his or her RSS reader, the RSS reader may check updated information on the website, and may download any updates, without a need to visit the website every time to search for updated information.

The keyword detecting apparatus 100 may include an RSS collector 110, and a keyword detector 120. The RSS collector 110 may collect RSS information, and the keyword detector 120 may analyze the RSS information and detect a keyword.

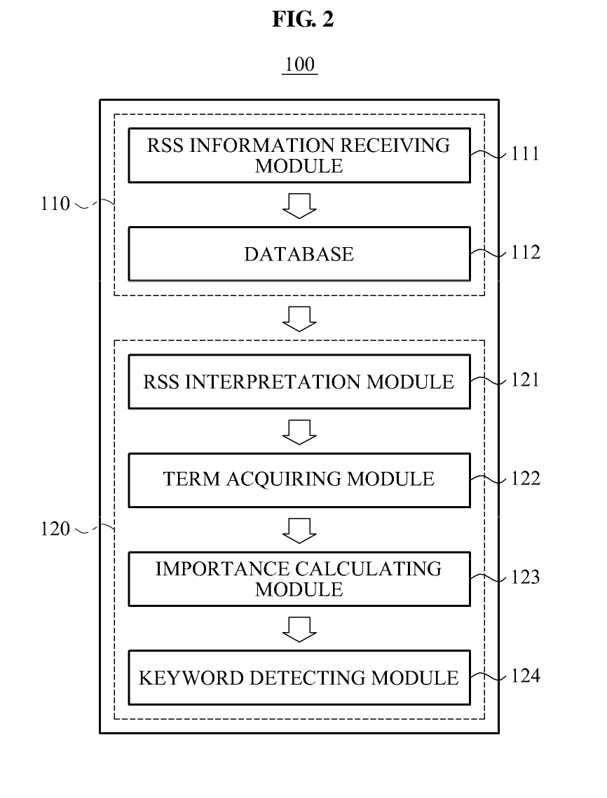

Hereinafter, an operation method of the keyword detecting apparatus 100 will be further described with reference to FIGS. 2 through 5.

FIG. 2 is a block diagram illustrating the keyword detecting apparatus 100.

As shown in FIG. 2, the keyword detecting apparatus 100 includes the RSS collector 110, and the keyword detector 120. The RSS collector 110 may collect RSS information, and may include an RSS information receiving module 111, and a database 112, as shown in FIG. 2.

The RSS information receiving module 111 may receive RSS information from the plurality of RSS servers, and the database 112 may store and maintain the received RSS information. Specifically, the RSS information receiving module 111 may determine the RSS servers based on range data that is set in advance, may request the RSS servers to transmit the RSS information, and may receive the RSS information from the RSS servers. For example, the RSS information receiving module 111 may send a request for RSS information to RSS servers within a range that is set in advance based on a user preference or a purpose of an application, may receive the requested RSS information, and may store the received RSS information in the database 112.

The keyword detector 120 may analyze the RSS information, and may detect a keyword. Additionally, the keyword detector 120 may include an RSS interpretation module 121, a term acquiring module 122, an importance calculating module 123, and a keyword detecting module 124.

The RSS interpretation module 121 may extract a unit element from the RSS information. Specifically, the RSS interpretation module 121 may interpret collected RSS information, and may extract a unit element that forms the RSS information. Here, the unit element may include, for example, a title and a description of the RSS information.

The term acquiring module 122 may extract terms from the RSS information. Specifically, the term acquiring module 122 may extract the terms based on at least one of a morpheme analysis algorithm and a whitespace separation algorithm.

Additionally, the term acquiring module 122 may extract terms from the unit element. Here, the terms may form the unit element. For example, the term acquiring module 122 may extract terms that form the title and the description, from the unit element.

The importance calculating module 123 may calculate importance levels of the terms, and the keyword detecting module 124 may select a keyword among the terms based on the importance levels. Specifically, the importance calculating module 123 may determine the importance levels for each term, and the keyword detecting module 124 may compare or analyze the importance levels of the terms and may select at least one keyword among the terms. Additionally, the importance calculating module 123 may calculate the importance levels based on at least one of a frequency of an occurrence, a scarcity level, and a user preference with respect to the terms.

Furthermore, the importance calculating module 123 may calculate the importance levels based on a Term Frequency-Inverse Document Frequency (TF-IDF) of the terms. For example, the importance calculating module 123 may calculate a Term Frequency (TF) of a first term among the terms, may calculate a Document Frequency (DF) of the first term, and may calculate an importance level of the first term based on the calculated TF and the calculated DF. In this example, the importance level of the first term may be obtained by multiplying the TF of the first term by an Inverse Document Frequency (IDF) of the first term. In addition, the importance calculating module 123 may calculate the importance levels of the terms in the same manner as the first term.

Additionally, the keyword detecting module 124 may select, as the keyword, a term having an importance level that is equal to or greater than a reference value, from among the terms.

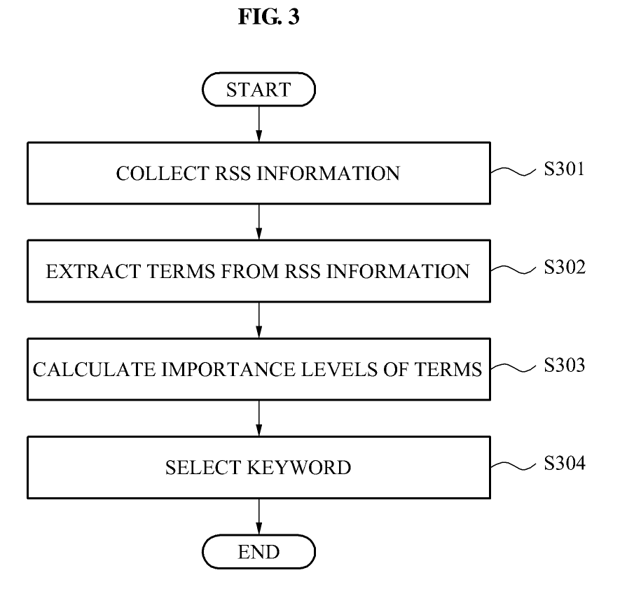

FIG. 3 is a flowchart illustrating a keyword detecting method according to an embodiment of the present invention.

As shown in FIG. 3, the keyword detecting method includes operations 5301 through S304. Operation S301 may be performed by the RSS collector 110, and operations S302 through S304 may be performed by the keyword detector 120.

In operation S301, the RSS collector 110 may collect RSS information. Specifically, the RSS collector 110 may receive RSS information from the plurality of RSS servers, and may store and maintain the received RSS information in the database 112. Here, the RSS collector 110 may determine the RSS servers based on range data that is set in advance, may request the RSS servers to transmit the RSS information, and may receive the RSS information from the RSS servers. For example, the RSS collector 110 may send a request for RSS information to RSS servers within a range that is set in advance based on a user preference or a purpose of an application, may receive the requested RSS information, and may store the received RSS information in the database 112.

In operation S302, the keyword detector 120 may extract terms from the RSS information. Here, the term acquiring module 122 may extract the terms based on at least one of a morpheme analysis algorithm and a whitespace separation algorithm.

Additionally, the keyword detector 120 may interpret the RSS information, may extract a unit element from the RSS information, and may extract terms that form the unit element from the unit element. Here, the unit element may include, for example, a title and a description of the RSS information.

In operation S303, the keyword detector 120 may calculate importance levels of the terms. In operation S304, the keyword detector 120 may select a keyword among the terms based on the importance levels. Specifically, the keyword detector 120 may determine the importance levels for each term, may compare or analyze the importance levels of the terms, and may select at least one keyword among the terms. Additionally, the keyword detector 120 may calculate the importance levels based on at least one of a frequency of an occurrence, a scarcity level, and a user preference with respect to the terms.

Additionally, the keyword detector 120 may calculate the importance levels based on a TF-IDF of the terms. For example, the keyword detector 120 may calculate a TF of a first term among the terms, may calculate a DF of the first term, and may calculate an importance level of the first term based on the calculated TF and the calculated DF. In this example, the importance level of the first term may be obtained by multiplying the TF of the first term by the IDF of the first term. Moreover, the keyword detector 120 may calculate the importance levels of the terms in the same manner as the first term.

Furthermore, the keyword detector 120 may select, as the keyword, a term having an importance level that is equal to or greater than a reference value, from among the terms.

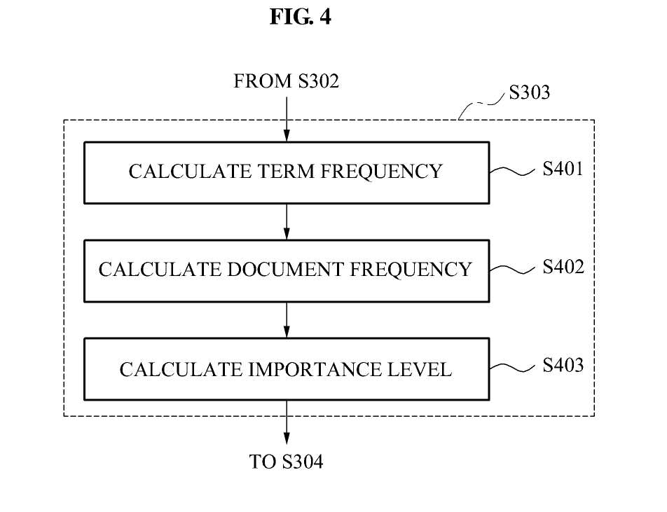

FIG. 4 is a flowchart illustrating operation S303 of calculating the importance levels of the terms according to an embodiment of the present invention.

As shown in FIG. 4, operation S303 includes operations S401 through S403. Here, operations S401 through S403 may be performed by the keyword detector 120.

In operation S401, the keyword detector 120 may calculate the TF of the first term among the terms. Specifically, the keyword detector 120 may calculate TFs for each term based on Equation 1 below. Here, the TF of the first term may be a variable that reflects a characteristic in which an importance level of the first term increases in proportion to a number of times the first term appears in a particular document.

$${tf}_{i , j} = \frac{{n}_{i , j}}{{\sum }_{k}^{ } {n}_{k , j}} \qquad [ Equation 1 ]$$

In Equation 1, “j” denotes a document index, and “i” denotes a term index in a j-th document. Additionally, a denominator in Equation 1 denotes a number of occurrences of all terms in document “dⱼ” are found, and “n_{i,j}” denotes a number of occurrences of term “tᵢ” in the document “dⱼ.”

In operation S402, the keyword detector 120 may calculate the DF of the first term. Additionally, the keyword detector 120 may calculate IDFs for each term based on Equation 2 below. Here, an IDF of the first term may be a variable that reflects a characteristic in which an importance level of the first term increases in inverse proportion to a number of times the first term appears in all documents.

$${idf}_{i} = log \frac{\vert D \vert}{\vert \{ {d}_{j} \text{:} {t}_{i} ∈ {d}_{j} \} \vert} \qquad [ Equation 2 ]$$

In Equation 2, |D| denotes a total number of documents in the corpus, and |{dⱼ:tᵢεdⱼ}| denotes a number of documents where the term “tᵢ” appears.

In operation S403, the keyword detector 120 may calculate the importance level of the first term based on the TF and the DF. For example, the keyword detector 120 may determine, as the importance level, a value obtained by multiplying the TF of the first term by the IDF of the first term. Similarly, the keyword detector 120 may determine importance levels for each term by multiplying each TF by each IDF.

Additionally, the keyword detector 120 may use acquired RSS information to calculate TFs, and may calculate TFs with respect to all acquired documents, or with respect to documents containing a corresponding term. Furthermore, the keyword detector 120 may separate a title element and a description element from a document, and may use the title and description elements to calculate each TF.

To calculate an IDF, the keyword detector 120 may acquire a total number of documents managed by the keyword detector 120, and a number of documents where the term “tᵢ” appears. Alternatively, the keyword detector 120 may calculate an IDF by collecting documents on a web, or by using a service that provides a number of documents matched to a predetermined term.

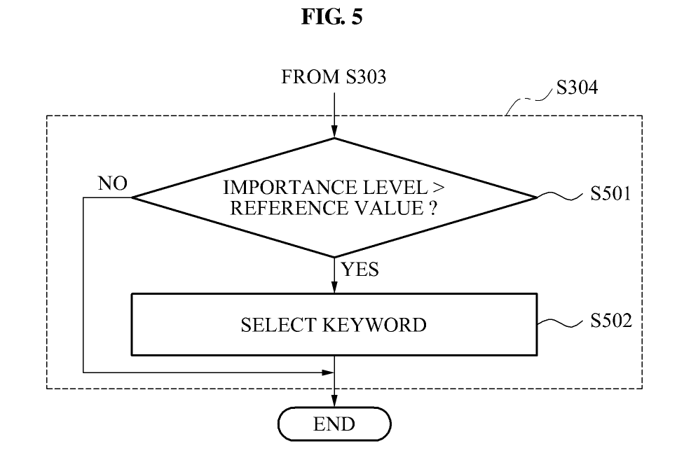

FIG. 5 is a flowchart illustrating operation S304 of selecting the keyword among the terms according to an embodiment of the present invention.

As shown in FIG. 5, operation S304 includes operations S501 and S502. Here, operations S501 and S502 may be performed by the keyword detector 120.

In operation S501, the keyword detector 120 may determine whether each importance level of each term is greater than a predetermined reference value, and may select, as the keyword, a term having an importance level that is equal to or greater than the predetermined reference value, from among the terms.

For example, the keyword detector 120 may separate and extract terms from RSS information, and may calculate an importance level of a first term among the terms. When the importance level of the first term is determined to be equal to or greater than a predetermined reference value, the keyword detector 120 may add the first term to a keyword list, to select the first term as a keyword.

However, the keyword detecting method according to the embodiment of the present invention may involve the scope of rights of various embodiments for selecting a keyword among terms based on importance levels of the terms. For example, when the importance level of the first term is determined to be equal to or greater than or less than a detection measure value that is calculated in advance, the keyword detector 120 may determine, as a keyword, the first term or a term having a relatively high importance level among the terms. Additionally, the keyword detector 120 may apply at least two detection measure values in combination, to select the keyword among the terms.

Additionally, details other than those described above with respect to operations S301 through S304 may be similar to those described above with reference to FIGS. 1 and 2, or may be easily inferred by those skilled in the art based on those described above, and accordingly, further description thereof will be omitted herein.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for detecting a keyword, the apparatus comprising:
a Really Simple Syndication (RSS) collector to collect RSS information; and
a keyword detector to analyze the RSS information and to detect a keyword.

2. The apparatus of claim 1, wherein the RSS collector comprises:
an RSS information receiving module to receive RSS information from a plurality of RSS servers; and
a database to maintain the received RSS information.

3. The apparatus of claim 2, wherein the RSS information receiving module determines the RSS servers based on range data, and requests the RSS servers to transmit the RSS information, the range data being set in advance.

4. The apparatus of claim 1, wherein the keyword detector comprises:
a term acquiring module to extract terms from the RSS information;
an importance calculating module to calculate importance levels of the terms; and
a keyword detecting module to select a keyword among the terms based on the importance levels.

5. The apparatus of claim 4, wherein the keyword detector further comprises an RSS interpretation module to extract a unit element from the RSS information,
wherein the term acquiring module extracts terms from the unit element, the terms forming the unit element.

6. The apparatus of claim 4, wherein the term acquiring module extracts the terms based on at least one of a morpheme analysis algorithm and a whitespace separation algorithm.

7. The apparatus of claim 4, wherein the importance calculating module calculates the importance levels of the terms based on at least one of a frequency of an occurrence, a scarcity level, and a user preference with respect to the terms.

8. The apparatus of claim 4, wherein the importance calculating module calculates the importance levels of the terms based on a Term Frequency-Inverse Document Frequency (TF-IDF) of the terms.

9. The apparatus of claim 4, wherein the importance calculating module calculates a Term Frequency (TF) of a first term among the terms, calculates a Document Frequency (DF) of the first term, and calculates an importance level of the first term based on the calculated TF and the calculated DF.

10. The apparatus of claim 4, wherein the keyword detecting module selects, as the keyword, a term having an importance level being equal to or greater than a reference value, from among the terms.

11. A method for detecting a keyword, the method comprising:
collecting RSS information;
extracting terms from the RSS information;
calculating importance levels of the terms; and
selecting a keyword from among the terms based on the importance levels.

12. The method of claim 11, wherein the calculating comprises:
calculating a TF of a first term among the terms;
calculating a DF of the first term; and
calculating an importance level of the first term based on the calculated TF and the calculated DF.

13. The method of claim 12, wherein the selecting comprises selecting the first term as the keyword based on the importance level of the first term.

14. The method of claim 11, wherein the collecting comprises receiving RSS information from a plurality of servers, and maintaining the received RSS information in a database.

15. The method of claim 14, wherein the collecting comprises determining the RSS servers based on range data, and requesting the RSS servers to transmit the RSS information, the range data being set in advance.

16. The method of claim 11, wherein the extracting comprises extracting a unit element from the RSS information, and extracting terms from the unit element, the terms forming the unit element.

17. The method of claim 11, wherein the extracting comprises extracting the terms based on at least one of a morpheme analysis algorithm and a whitespace separation algorithm.

18. The method of claim 11, wherein the calculating comprises calculating the importance levels of the terms based on at least one of a frequency of an occurrence, a scarcity level, and a user preference with respect to the terms.

19. The method of claim 11, wherein the calculating comprises calculating the importance levels of the terms based on a TF-IDF of the terms.

20. The method of claim 11, wherein the selecting comprises selecting, as the keyword, a term having an importance level being equal to or greater than a reference value from among the terms.
